(19) United States
(12) Patent Application Publication
(10) Pub. No.: US 2017/0327082 A1
(43) Pub. Date: Nov. 16, 2017

(54) END-TO-END ACCOMMODATION FUNCTIONALITY FOR PASSENGERS OF FULLY AUTONOMOUS SHARED OR TAXI-SERVICE VEHICLES

(71) Applicant: GM Global Technology Operations LLC, Detroit, MI (US)

(72) Inventors: Gila Kamhi, Zichron Yaakov (IL); Asaf Degani, Tel Aviv (IL); Eli Tzirkel-Hancock, Ra'anana (IL); Claudia V. Goldman-Shenhar, Mevasseret Zion (IL)

(21) Appl. No.: 15/585,489

(22) Filed: May 3, 2017

Related U.S. Application Data
(60) Provisional application No. 62/335,553, filed on May 12, 2016.

(51) Int. Cl. B60R 25/20; G06Q 30/00; G05D 1/00; B60H 1/00; B60R 25/102; G06Q 30/02; G06Q 10/02

(52) U.S. Cl. CPC B60R 25/2081; G06Q 30/0202; G06Q 30/016; G06Q 10/02; B60H 1/00735; B60R 25/102; B60H 1/00742; G05D 1/0088

(57) ABSTRACT

A system, for implementation with an autonomous vehicle, includes a hardware-based processing unit, a human-machine interface, and a non-transitory storage device including a registration module that, when executed by the hardware-based processing unit performs passenger-registration functions. The functions include obtaining passenger registration data indicating multiple identifications corresponding respectively to multiple passengers registered to use an autonomous-vehicle driving service, and determines whether each of multiple persons attempting to ride in the autonomous vehicle is one of the passengers registered for the autonomous-vehicle driving service, yielding respective authentications regarding persons determined to be one for the passengers registered for the service. The storage device also includes a vehicle-passenger communication module that, when executed, initiates intra-vehicle communication with passengers authenticated by way of the human-machine interface, and in some cases communicates with authenticated passengers at least intermittently from start to end of the autonomous ride, and in a personalized manner.

### TECHNICAL FIELD

The present disclosure relates generally to systems and methods for accommodating passengers of fully autonomous vehicles, such as shared or cab rides, and, more particularly, to systems, algorithms, and processes for interacting with the passengers to schedule the rides, during the rides, and after, to improve passenger experience and safety. Security features in various embodiments include a multi-level authentication process, and a process of initiating communications with a vehicle operator or customer-service center in questionable situations such as if a non-scheduled passenger is attempting to ride.

### BACKGROUND

This section provides background information related to the present disclosure which is not necessarily prior art.

Manufacturers are increasingly producing vehicles having higher levels of driving automation. Features such as adaptive cruise control and lateral positioning have become popular and are precursors to greater adoption of fully autonomous-driving-capable vehicles.

While availability of autonomous-driving-capable vehicles is on the rise, users' familiarity and comfort with autonomous-driving functions will not necessarily keep pace. User comfort with the automation is an important aspect in overall technology adoption and user experience.

Also, with highly automated vehicles expected to be commonplace, markets for fully-autonomous taxi services and shared vehicles are developing. In addition to becoming familiar with the automated functionality, customers interested in these services will need to become accustomed, not only to riding in an autonomous vehicle, but also being driven by a driverless vehicle that is not theirs, and in some cases, with co-passengers whom they may not know.

Uneasiness with automated-driving functionality, and possibly also with the shared-vehicle experience, can lead to reduced use of the autonomous driving capabilities, such as by the user not engaging, or disengaging, autonomous-driving operation. Or the user may not commence, or may discontinue, a shared-vehicle ride. In some cases, the user continues to use the autonomous functions, but with a relatively low level of satisfaction.

An uncomfortable user may also be less likely to order a fully-autonomous-driving service again, whether the ride would be shared. And they thus may be less likely to use, or even to learn about, more-advanced autonomous-driving capabilities available for shared or solo rides.

Levels of adoption can also affect marketing and sales of autonomous vehicles. Increases in users' trust in autonomous-driving systems, and in use of shared autonomous vehicles, generally, users will be more likely to purchase an autonomous-driving-capable vehicle, schedule an automated taxi, share an automated-vehicle ride, or recommend that others do the same.

### SUMMARY

In one aspect, the present technology involves a system, for implementation with an autonomous vehicle, includes a hardware-based processing unit, a human-machine interface, and a non-transitory storage device including a registration module that, when executed by the hardware-based processing unit performs passenger-registration functions. The functions include obtaining passenger registration data indicating multiple identifications corresponding respectively to multiple passengers registered to use an autonomous-vehicle driving service, and determines whether each of multiple persons attempting to ride in the autonomous vehicle is one of the passengers registered for the autonomous-vehicle driving service, yielding respective authentications regarding persons determined to be one for the passengers registered for the service.

The storage device also includes a vehicle-passenger communication module that, when executed, initiates intra-vehicle communication with passengers authenticated by way of the human-machine interface, and in some cases communicates with authenticated passengers at least intermittently from start to end of the autonomous ride, and in a personalized manner.

The vehicle-passenger communication module may include a passenger-greeting sub-module that, when executed by the hardware-based processing unit, provides an introduction communication to the at least one passenger. The passenger greeting sub-module, when executed, generates the introduction communication being personalized to the at least one passenger in some implementations. The introduction communication may include a name of the at least one passenger.

In various embodiments, the vehicle-passenger communication module includes a concierge sub-module that, when executed, delivers an inquiry to the at least one passenger by way of the human-machine interface.

The concierge sub-module in some implementations is configured to receive a passenger response and initiates an action based on the response.

The concierge sub-module in some implementations determines a manner to adjust a vehicle apparatus personal to the at least one passenger.

The vehicle apparatus may include a climate apparatus and the concierge sub-module, when executed, determines the manner by which to adjust the climate apparatus based on passenger-data indicating a preference or desire of the at least one passenger.

The vehicle apparatus comprises an infotainment apparatus, and the concierge sub-module, when executed, determines the manner by which to adjust the infotainment apparatus based on passenger-data indicating a preference or desire of the at least one passenger.

The vehicle apparatus includes an autonomous-driving apparatus in various embodiments, and the concierge sub-module, when executed, determines the manner by which to adjust the autonomous-driving apparatus based on passenger-data indicating a preference or desire of the at least one passenger.

In various embodiments, the storage device comprises a closing-communication sub-module that, when executed, determines a passenger-personalized end-of-ride communication to provide to the at least one passenger near the end of a ride.

The passenger-personalized end-of-ride communication can be configured to advise the at least one passenger that their destination is approaching. And the passenger-personalized end-of-ride communication can be configured to determine whether the at least one passenger would like the system to affect a post-ride passenger activity.

The post-ride passenger activity may include at least one of a restaurant reservation, a hotel reservation, and entertainment reservations.

Determining whether each of multiple persons attempting to ride in the autonomous vehicle is one of the passengers registered for the autonomous-vehicle driving service may include a lower-level security check and a higher-level security check.

The vehicle-passenger communication module, when executed, may determines a position of the at least one passenger in the vehicle, and provide the introduction communication by way of a human-machine interface of the vehicle focused on the position in the autonomous vehicle for receipt primarily by the at least one passenger.

The registration module, when executed, may determines an authentication-failure action to take in connection with each non-authenticated person, who attempting to ride in the autonomous vehicle but determined to not be registered.

The authentication-failure action may include one or more of: providing an alert communication to a passenger of the vehicle; providing an alert communication to the non-authenticated person; providing an alert communication to an authority; applying a demerit to respective accounts for each non-authenticated person; and adjusting the respective accounts so that each non-authenticated person can no longer use the autonomous-vehicle driving service.

In another aspect, the technology relates to a system for implementation with an autonomous vehicle, including a non-transitory storage device including the vehicle-passenger communication module, including the passenger-greeting sub-module, the concierge sub-module that, when executed by the hardware-based processing unit, delivers an inquiry to the at least one passenger by way of the human-machine interface and/or determines a manner to adjust a vehicle apparatus personal to the at least one passenger; and closing-communication sub-module that, when executed by the hardware-based processing unit, determines a passenger-personalized end-of-ride communication to provide to the at least one passenger near the end of a ride.

In another aspect, the systems of the present technology include an application configured to (i) register passengers to use fully autonomous vehicles, such as shared or cab rides, (ii) authenticate the passengers upon arrival at the vehicle, (iii) interact via a human-machine interfaces (HMI) with the passengers during the ride, and (iv) obtain feedback about the ride from the passengers.

The authentication (ii) in various embodiments includes a multi-level authentication process. Further regarding the authentication, the system (v) takes one or more predetermined steps if an unauthorized person is attempting to use the vehicle, such as providing a communication indicating the failed registration to a relevant party, such as the unauthorized person, other passengers, a vehicle operator, a customer-service center, and first responders or another authority.

In various embodiments, the system is further configured to (vi) maintain a user profile for each passenger, including updating the same with any of various information. Example information includes user history, such as regarding use of the ride service, and preference information, such as user likes, dislikes, preferred driving style (e.g., prefers side roads over highway; prefers greater-than-average following distance), music type, media volume, climate (e.g., hvac) settings, and preference for which and how other infotainment, such as news channel, etc., is provided.

Versions or instances of the application can be maintained at any of various systems, such as subject vehicles user devices—such as phones, tablets, laptops, etc.—and remote servers or customer-service center computers.

In contemplated embodiments, users can interact with the system by channels other than by an application or program, such as by a phone touch-tone system, or phone call center personnel. Such non-direct channels may in turn interface with the application or program.

Other aspects of the present technology will be in part apparent and in part pointed out hereinafter.

### DESCRIPTION OF THE DRAWINGS

FIG. 1 illustrates schematically an example vehicle of transportation, with local and remote personal computing devices, according to embodiments of the present technology.

FIG. 2 illustrates schematically more details of the example vehicle computer of FIG. 1 in communication with the local and remote computing devices.

FIG. 3 shows another view of the vehicle, emphasizing example memory components.

FIG. 4 shows interactions between the various components of FIG. 3, including with external systems.

The figures are not necessarily to scale and some features may be exaggerated or minimized, such as to show details of particular components.

### DETAILED DESCRIPTION

As required, detailed embodiments of the present disclosure are disclosed herein. The disclosed embodiments are merely examples that may be embodied in various and alternative forms, and combinations thereof. As used herein, for example, exemplary, and similar terms, refer expansively to embodiments that serve as an illustration, specimen, model or pattern.

In some instances, well-known components, systems, materials or processes have not been described in detail in order to avoid obscuring the present disclosure. Specific structural and functional details disclosed herein are therefore not to be interpreted as limiting, but merely as a basis for the claims and as a representative basis for teaching one skilled in the art to employ the present disclosure.

### I. TECHNOLOGY INTRODUCTION

The present disclosure describes, by various embodiments, algorithms, systems, and processes for accommodating passengers of fully autonomous vehicles, such as shared or cab rides. The systems interact with the passengers for scheduling the ride, during the ride, and after, to improve passenger safety and experience.

Security features in various embodiments include a multi-level authentication process, and communications with a vehicle operator or customer-service center in the event that a non-scheduled passenger is attempting to ride.

While select examples of the present technology describe transportation vehicles or modes of travel, and particularly automobiles, the technology is not limited by the focus. The concepts can be extended to a wide variety of systems and devices, such as other transportation or moving vehicles including aircraft, watercraft, busses, the like, and other.

And while select examples of the present technology describe fully autonomous vehicles, the technology is not limited to use in autonomous vehicles (fully or partially autonomous), or to times in which an autonomous-capable vehicle is being driven autonomously. The system can be used by a shared-ride or cab-like service having a driver who at times, or never, uses autonomous-driving capabilities. Or by a parent, friend, or acquaintance who is giving a ride to one or more passengers, whether they use autonomous capabilities.

References herein to characteristics of a passenger, and communications provided for receipt by a passenger, for instance, should be considered to disclose analogous implementations regarding a vehicle driver during manual vehicle operation. During fully autonomous driving, the ‘driver’ is considered a passenger.

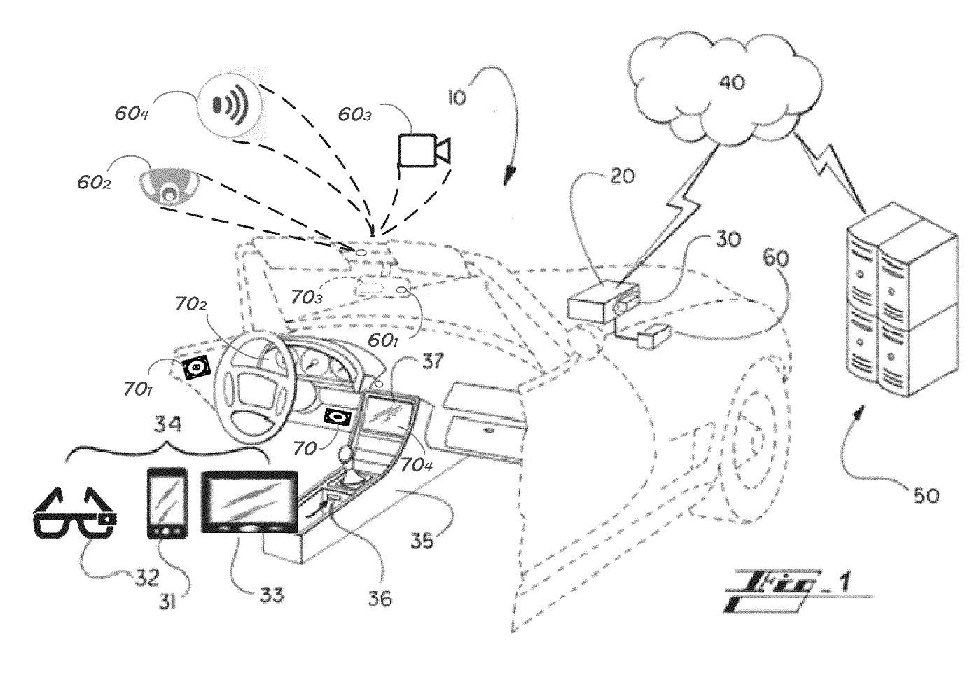

### II. HOST VEHICLE—FIG. 1

Turning now to the figures and more particularly the first figure, FIG. 1 shows an example host vehicle of transportation 10, provided by way of example as an automobile. The vehicle is in various embodiments preferably a fully autonomous vehicle, capable of carrying passengers along a route without a human driver.

The vehicle 10 includes a hardware-based controller or controller system 20. The hardware-based controller system 20 includes a communication sub-system 30 for communicating with mobile or local computing devices 34 and/or external networks 40.

By the external networks 40, such as the Internet, a local-area, cellular, or satellite network, vehicle-to-vehicle, pedestrian-to-vehicle or other infrastructure communications, etc., the vehicle 10 can reach mobile or local systems 34 or remote systems 50, such as remote servers.

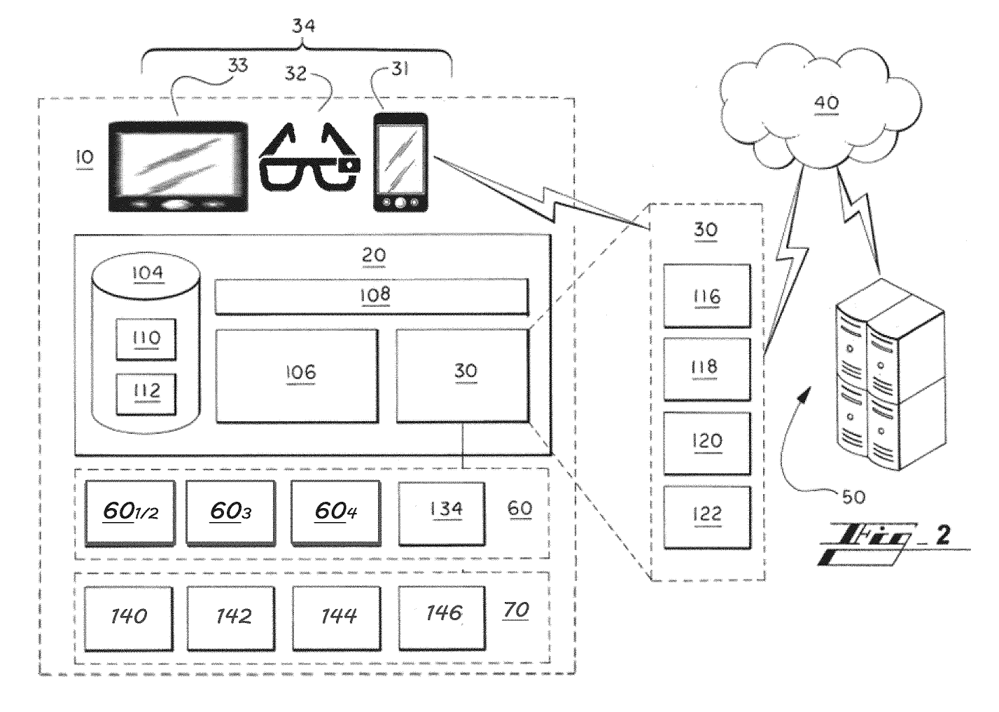

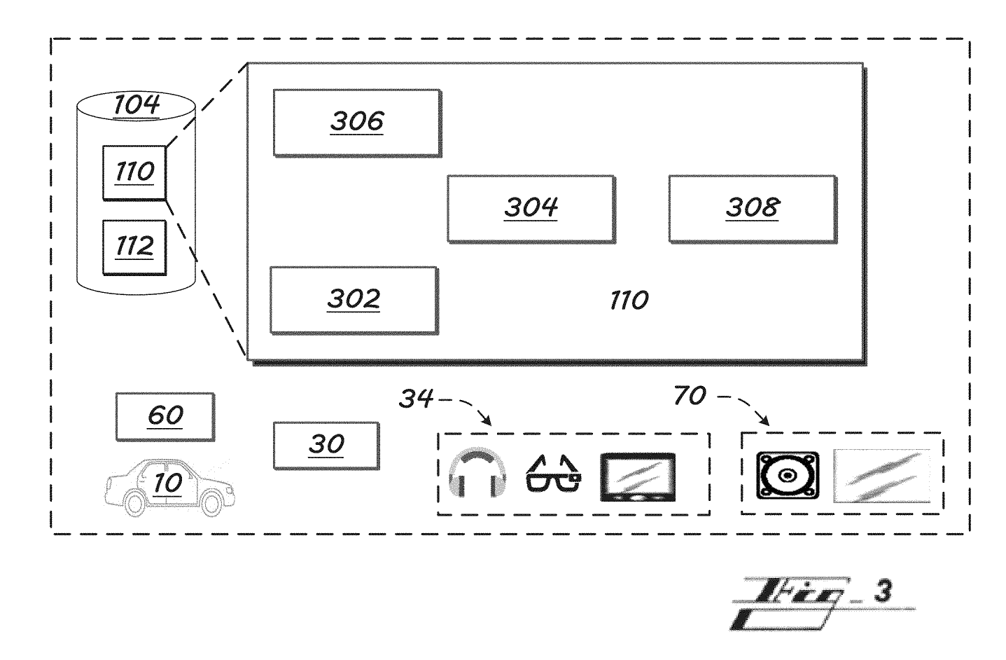

Example mobile devices 34 include a user smartphone 31, a user wearable device 32, and a user tablet or other mobile computer 33, such as a laptop, and are not limited to these examples. Example wearables 32 include smart-watches, eyewear, as shown in FIGS. 2 and 3, and smart-jewelry, such as earrings, necklaces, and lanyards.

Mobile devices can be used in various ways by the system (e.g., controller 20), including to authenticate identity of a present or potential passenger of the vehicle 10, as described further below.

Another example local device is an on-board device (OBD) (not shown in detail), such as a wheel sensor, a brake sensor, an accelerometer, a rotor-wear sensor, throttle-position sensor, steering-angle sensor, revolutions-per-minute (RPM) indicator, brake-force sensors, other vehicle state or dynamics-related sensor for the vehicle, with which the vehicle is retrofitted with after manufacture. The OBD(s) can include or be a part of the sensor sub-system referenced below by numeral 60.

The vehicle controller system 20, which in contemplated embodiments includes one or more microcontrollers, can communicate with OBDs via a controller area network (CAN). The CAN message-based protocol is typically designed for multiplex electrical wiring with automobiles, and CAN infrastructure may include a CAN bus. The OBD can also be referred to as vehicle CAN interface (VCI) components or products, and the signals transferred by the CAN may be referred to as CAN signals. Communications between the OBD(s) and the primary controller or microcontroller 20 are in other embodiments executed via similar or other message-based protocol.

The vehicle 10 also has various mounting structures 35. The mounting structures 35 include a central console, a dashboard, and an instrument panel. The mounting structure 35 includes a plug-in port 36—a USB port, for instance—and a visual display 37, such as a touch-sensitive, input/output (I/O), human-machine interface (HMI).

The vehicle 10 also has a sensor sub-system 60 including sensors providing information to the controller system 20. The sensor input to the controller 20 is shown schematically at the right, under the vehicle hood, of FIG. 2. Example sensors having base numeral 60 (60₁, 60₂, etc.) are also shown.

Sensor data relates to features such as vehicle operations, vehicle position, and vehicle pose, passenger characteristics, such as biometrics or physiological measures, and environmental-characteristics pertaining to a vehicle interior or outside of the vehicle 10.

Example sensors include a camera 60₁ positioned in a rear-view mirror of the vehicle 10, a dome or ceiling camera 60₂ positioned in a header of the vehicle 10, a world-facing camera 60₃ (facing away from vehicle 10), and a world-facing range sensor 60₄.

Intra-vehicle-focused sensors 60₁, 60₂, such as cameras and microphones, are configured to sense presence of people, activities or people, or other cabin activity or characteristics.

The sensors can also be used for authentication purposes, in a pre-registration and/or registration process. This subset of sensors are described more below.

World-facing sensors 60₃, 60₄ sense characteristics about an environment 11 comprising, for instance, billboards, buildings, other vehicles, traffic signs, traffic lights, pedestrians, objects in the sensor purview, etc. They can also sense people approaching the vehicle, such as registered passengers, and possibly individuals seeking to enter the car though they are not registered.

The OBDs mentioned can be considered as local devices, sensors of the sub-system 60, or both in various embodiments.

Local devices 34, such as a passenger phone, wearable, or plug-in device, can be considered as sensors 60, as well. They can be used as sensors, for instance, in embodiments in which the vehicle 10 uses data from the device 34, such as data from a sensor of the device 34. The vehicle system can use data from a user smartphone indicating passenger-physiological traits of a user sensed by a biometric sensor of the phone.

The vehicle 10 also includes cabin output components 70, such as sound speakers 701, and an instruments panel or display 702. The output components may also include a dash or center-stack display screen 703, a rear-view-mirror screen 70₄—to display, for instance, imaging from a vehicle backup camera), and any vehicle visual display device 37.

### III. ON-BOARD COMPUTING ARCHITECTURE—FIG. 2

FIG. 2 illustrates in more detail the hardware-based computing or controller system 20 of FIG. 1. The controller system 20 can be referred to by other terms, such as computing apparatus, controller, controller apparatus, or such descriptive term, and can be or include one or more microcontrollers, as referenced above.

The controller system 20 is in various embodiments part of the mentioned greater system 10, such as a vehicle.

The controller system 20 includes a non-transitory, hardware-based computer-readable storage medium, or data storage device 104 and a hardware-based processing unit 106. The processing unit 106 is connected or connectable to the computer-readable storage device 104 by way of a communication link 108, such as a computer bus or wireless components.

The processing unit 106 can be referenced by other names, such as processor, processing hardware unit, the like, or other.

The processing unit 106 can include or be multiple processors, which could include distributed processors or parallel processors in a single machine or multiple machines. The processing unit 106 can be used in supporting a virtual processing environment.

The processing unit 106 could include a state machine, application specific integrated circuit (ASIC), or a programmable gate array (PGA) including a Field PGA, for instance. References herein to the processing unit executing code or instructions to perform operations, acts, tasks, functions, steps, or the like, could include the processing unit performing the operations directly and/or facilitating, directing, or cooperating with another device or component to perform the operations.

In various embodiments, the data storage device 104 is any of a volatile medium, a non-volatile medium, a removable medium, and a non-removable medium.

The term computer-readable media and variants thereof, as used in the specification and claims, refer to tangible storage media. The media can be a device, and can be non-transitory.

In various embodiments, the storage media includes volatile and/or non-volatile, removable, and/or non-removable media, such as, for example, random access memory (RAM), read-only memory (ROM), electrically erasable programmable read-only memory (EEPROM), solid state memory or other memory technology, CD ROM, DVD, BLU-RAY, or other optical disk storage, magnetic tape, magnetic disk storage or other magnetic storage devices.

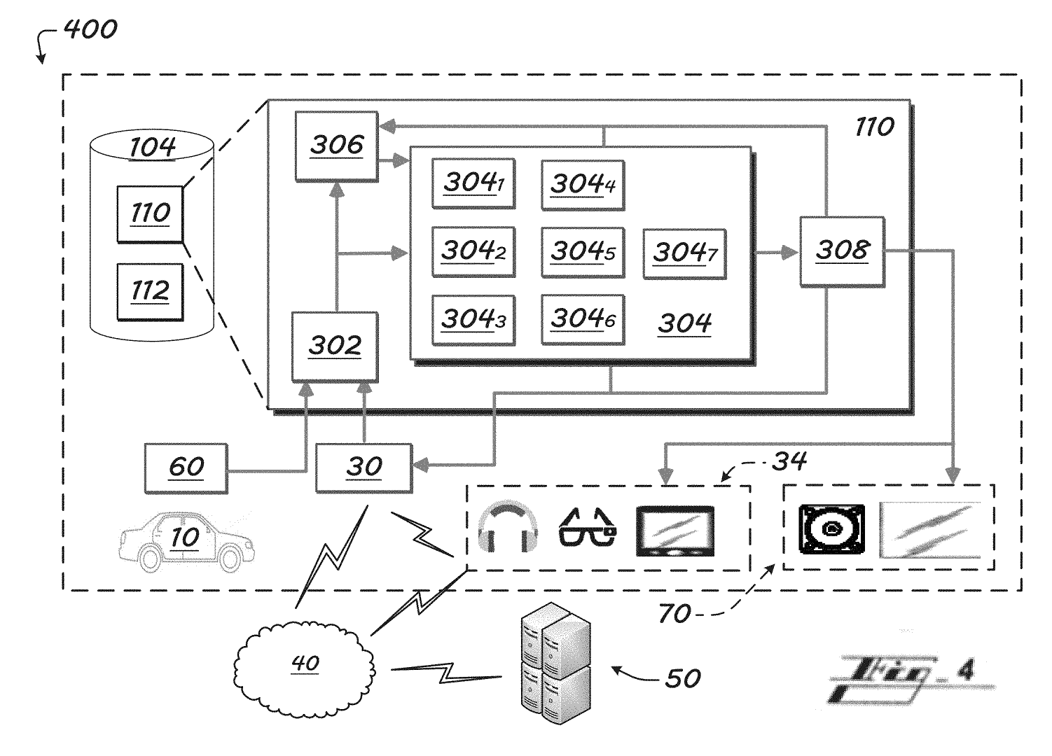

The data storage device 104 includes one or more storage modules 110 storing computer-readable code or instructions executable by the processing unit 106 to perform the functions of the controller system 20 described herein. The modules and functions are described further below in connection with FIGS. 3 and 4.

The data storage device 104 in various embodiments also includes ancillary or supporting components 112, such as additional software and/or data supporting performance of the processes of the present disclosure, such as one or more user profiles or a group of default and/or user-set preferences.

As provided, the controller system 20 also includes a communication sub-system 30 for communicating with local and external devices and networks 34, 40, 50. The communication sub-system 30 in various embodiments includes any of a wire-based input/output (i/o) 116, at least one long-range wireless transceiver 118, and one or more short- and/or medium-range wireless transceivers 120. Component 122 is shown by way of example to emphasize that the system can be configured to accommodate one or more other types of wired or wireless communications.

The long-range transceiver 118 is in various embodiments configured to facilitate communications between the controller system 20 and a satellite and/or a cellular telecommunications network, which can be considered also indicated schematically by reference numeral 40.

The short- or medium-range transceiver 120 is configured to facilitate short- or medium-range communications, such as communications with other vehicles, in vehicle-to-vehicle (V2V) communications, and communications with transportation system infrastructure (V2I). Broadly, vehicle-to-entity (V2X) can refer to short-range communications with any type of external entity (for example, devices associated with pedestrians or cyclists, etc.).

To communicate V2V, V2I, or with other extra-vehicle devices, such as local communication routers, etc., the short- or medium-range communication transceiver 120 may be configured to communicate by way of one or more short- or medium-range communication protocols. Example protocols include Dedicated Short-Range Communications (DSRC), WI-FI®, BLUETOOTH®, infrared, infrared data association (IRDA), near field communications (NFC), the like, or improvements thereof (WI-FI is a registered trademark of WI-FI Alliance, of Austin, Tex.; BLUETOOTH is a registered trademark of Bluetooth SIG, Inc., of Bellevue, Wash.).

By short-, medium-, and/or long-range wireless communications, the controller system 20 can, by operation of the processor 106, send and receive information, such as in the form of messages or packetized data, to and from the communication network(s) 40.

Remote devices 50 with which the sub-system 30 communicates are in various embodiments nearby the vehicle 10, remote to the vehicle, or both.

The remote devices 50 can be configured with any suitable structure for performing the operations described herein. Example structure includes any or all structures like those described in connection with the vehicle computing device 20. A remote device 50 includes, for instance, a processing unit, a storage medium including modules, a communication bus, and an input/output communication structure. These features are considered shown for the remote device 50 by FIG. 1 and the cross-reference provided by this paragraph.

While local devices 34 are shown within the vehicle 10 in FIGS. 1 and 2, any of them may be external to the vehicle and in communication with the vehicle.

Example remote systems 50 include a remote server (for example, application server), or a remote data, customer-service, and/or control center. A user computing or electronic device 34, such as a smartphone, can also be remote to the vehicle 10, and in communication with the sub-system 30, such as by way of the Internet or other communication network 40.

An example control center is the OnStar® control center, having facilities for interacting with vehicles and users, whether by way of the vehicle or otherwise (for example, mobile phone) by way of long-range communications, such as satellite or cellular communications. ONSTAR is a registered trademark of the OnStar Corporation, which is a subsidiary of the General Motors Company.

As mentioned, the vehicle 10 also includes a sensor sub-system 60 including sensors providing information to the controller system 20 regarding items such as vehicle operations, vehicle position, vehicle pose, user characteristics, such as biometrics or physiological measures, and/or the environment about the vehicle 10. The arrangement can be configured so that the controller system 20 communicates with, or at least receives signals from sensors of the sensor sub-system 60, via wired or short-range wireless communication links 116, 120.

In various embodiments, the sensor sub-system 60 includes at least one camera and at least one range sensor 60₄, such as radar or sonar, directed away from the vehicle, such as for supporting autonomous driving.

Visual-light cameras 60₃ directed away from the vehicle 10 may include a monocular forward-looking camera, such as those used in lane-departure-warning (LDW) systems. Embodiments may include other camera technologies, such as a stereo camera or a trifocal camera.

Sensors configured to sense external conditions may be arranged or oriented in any of a variety of directions without departing from the scope of the present disclosure. For example, the cameras 60₃ and the range sensor 60₄ may be oriented at each, or a select, position of, (i) facing forward from a front center point of the vehicle 10, (ii) facing rearward from a rear center point of the vehicle 10, (iii) facing laterally of the vehicle from a side position of the vehicle 10, and/or (iv) between these directions, and each at or toward any elevation, for example.

The range sensor 60₄ may include a short-range radar (SRR), an ultrasonic sensor, a long-range radar, such as those used in autonomous or adaptive-cruise-control (ACC) systems, sonar, or a Light Detection And Ranging (LiDAR) sensor, for example.

Other example sensor sub-systems 60 include the mentioned cabin sensors 60₁, 60₂ configured and arranged (e.g., positioned and fitted in the vehicle) to sense activity, people, cabin environmental conditions, or other features relating to the interior of the vehicle. Example cabin sensors 60₁, 60₂ include microphones, in-vehicle visual-light cameras, seat-weight sensors, user salinity, retina or other user characteristics, biometrics, or physiological measures, and/or the environment about the vehicle 10.

The cabin sensors (60₁, 60₂, etc.), of the vehicle sensors 60, may include one or more temperature-sensitive cameras (e.g., visual-light-based (3D, RGB, RGB-D), infra-red or thermographic) or sensors. In various embodiments, cameras are positioned preferably at a high position in the vehicle 10. Example positions include on a rear-view mirror and in a ceiling compartment.

Generally, a higher positioning for a camera or other intra-vehicle sensor reduces interference from lateral (including or fore/aft) obstacles, such as front-row seat backs blocking second- or third-row passengers, or blocking more of those passengers. A higher positioning reduces interference from lateral obstacles, such as front-row seat backs blocking second- or third-row passengers, or blocking more of those passengers. A higher positioned camera (light-based (e.g., RGB, RGB-D, 3D, or thermal or infra-red) or other sensor will likely be able to sense temperature of more of each passenger's body—e.g., torso, legs, feet.

Two example locations for cameras are indicated in FIG. 1 by reference numerals 60₁, 60₂—on at rear-view mirror and one at the vehicle header.

Other example sensor sub-systems 60 include dynamic vehicle sensors 134, such as an inertial-momentum unit (IMU), having one or more accelerometers, for instance, wheel sensors, or a sensor associated with a steering system (for example, steering wheel) of the vehicle 10.

The sensors 60 can include any sensor for measuring a vehicle pose or other dynamics, such as position, speed, acceleration, or height—e.g., vehicle height sensor.

The sensors 60 can include any known sensor for measuring an environment of the vehicle, including those mentioned above, and others such as a precipitation sensor for detecting whether and how much it is raining or snowing, a temperature sensor, and any other.

Sensors for sensing user characteristics include any biometric sensor, such as a retina or other eye scanner or sensor, thermal sensor, fingerprint scanner, facial-recognition sub-system including a camera, microphone associated with a voice recognition sub-system, a weight sensor, salinity sensor, breath-quality sensors (e.g., breathalyzer), a user-temperature sensor, electrocardiogram (ECG) sensor, Electrodermal Activity (EDA) or Galvanic Skin Response (GSR) sensors, Blood Volume Pulse (BVP) sensors, Heart Rate (HR) sensors, electroencephalogram (EEG) sensor, Electromyography (EMG), and user-temperature, a sensor measuring salinity level, the like, or other.

User-vehicle interfaces, such as a touch-sensitive display 37, buttons, knobs, the like, or other can also be considered part of the sensor sub-system 60.

FIG. 2 also shows the cabin output components 70 mentioned above. The output components in various embodiments include a mechanism for communicating with vehicle occupants. The components include but are not limited to sound speakers 140, visual displays 142, such as the instruments panel, center-stack display screen, and rear-view-mirror screen, and haptic outputs 144, such as steering wheel or seat vibration actuators. The fourth element 146 in this section 70 is provided to emphasize that the vehicle can include any of a wide variety of other in output components, such as components providing an aroma or light into the cabin.

### IV. ADDITIONAL VEHICLE COMPONENTS—FIG. 3

FIG. 3 shows an alternative view of the vehicle 10 of FIGS. 1 and 2 emphasizing example memory components, and showing associated devices.

As mentioned, the data storage device 104 includes one or more modules 110 including or defining algorithms for performing the processes of the present disclosure. And the device 104 may include ancillary components 112, such as additional software and/or data supporting performance of the processes of the present disclosure. The ancillary components 112 can include, for example, additional software and/or data supporting performance of the processes of the present disclosure, such as one or more user profiles or a group of default and/or user-set preferences.

Any of the code or instructions described can be part of more than one module. And any functions described herein can be performed by execution of instructions in one or more modules, though the functions may be described primarily in connection with one module by way of primary example. Each of the modules can be referred to by any of a variety of names, such as by a term or phrase indicative of its function.

Sub-modules can cause the processing hardware-based unit 106 to perform specific operations or routines of module functions. Each sub-module can also be referred to by any of a variety of names, such as by a term or phrase indicative of its function. Sub-modules can also be referred to as modules, such as in the claims, when the general module comprising the sub-modules is not present or at least not recited.

Example modules 110 shown include:
an input-interface module 302;
an activity module 304;
a database module 306; and
an output-interface module 308.

Other vehicle components shown include the vehicle communications sub-system 30 and the vehicle sensor sub-system 60.

Various input devices and systems can serve as input sources to the modules 110, and particularly to the input interface module 302. Example inputs from the communications sub-system 30 include identification signals from mobile devices, such as a device or user ID transmitted by RFID. The ID can be used to identify or register a mobile device, and so the corresponding user, to the vehicle 10, or at least preliminarily register the device/user to be followed by a higher-level registration.

A mobile device 34, for instance, can be used to generate information stored at the device 34 and shared with the vehicle 10 or remote server 50. For this, the device 34 may be configured to, for instance, to perform any of the functions of the present technology, such as receiving user input to schedule a ride with an autonomous vehicle, sending authentication communications (e.g., ID signal) to the vehicle 10, and receiving user input rating a ride experience.

As an example regarding registration and authentication, the vehicle 10 may, before a ride, receive a mobile-device- or user-identifying code and, receive an ID signal from the mobile device 34 when the user arrives to the vehicle—e.g., when they approach or enter the vehicle, depending on the functionality of the subject vehicle and programmed preference. The vehicle 10 may recognize the mobile-device signal as being from the same mobile-device that was used to schedule the ride, such as by matching a device identifier in the signal with a device identifier received with the request to schedule the ride.

Example input devices from the vehicle sensor sub-system 60 include and are not limited to:
bio-metric sensors providing bio-metric data regarding vehicle occupants, such as skin or body temperature for each occupant;
vehicle-occupant input devices, or human-machine interfaces (HMIs), such as a touch-sensitive screen, buttons, knobs, microphone, and the like;
cabin sensors providing data about characteristics within the vehicle, such as vehicle-interior temperature, in-seat weight sensors, and motion-detection sensors;
environment sensors providing data bout conditions about a vehicle, such as from external camera and distance sensors (e.g., LiDAR, radar); and
sources separate from the vehicle 10, such as local devices 34, devices worn by pedestrians, other vehicle systems, local infrastructure (local beacons, cellular towers, etc.), satellite systems, and remote systems, providing any of a wide variety of information, such as user-identifying data, user-history data, user selections or user preferences contextual data (weather, road conditions, navigation, etc.), program or system updates—remote systems can include, for instance, applications servers corresponding to application(s) operating at the vehicle 10 and any relevant user devices 34, computers of a user or supervisor (parent, work supervisor), vehicle-operator servers, customer-control center system, such as systems of the OnStar® control center mentioned, or a vehicle-operator system, such as that of a taxi company operating a fleet of which the vehicle 10 belongs, or of an operator of a ride-sharing service.

The view also shows example vehicle outputs 70, and user devices 34, which may be positioned in the vehicle 10. Outputs 70 can include and are not limited to:
vehicle speakers or audio output;
vehicle screens or visual output;
vehicle-dynamics actuators, such as those affecting autonomous driving (for instance, vehicle brake, throttle, steering);
vehicle climate actuators, such as those controlling HVAC system temperature, humidity, zone outputs, and fan speed(s); and
local and remote devices and systems, to which the system may provide a wide variety of information, such as user-identifying data, user-biometric data, user-history data, contextual data (weather, road conditions, etc.), instructions or data for use in providing notifications, alerts, or messages to the user or relevant entities such as authorities, first responders, parents, an operator or owner of a subject vehicle 10, or a customer-service center system such as of the OnStar® control center.

The modules, sub-modules, and their functions are described more below.

### V. ALGORITHMS AND PROCESSES—FIG. 4

V.A. Introduction to the Algorithms

FIG. 4 shows an example algorithm, represented schematically by a process flow 400, according to embodiments of the present technology. Though a single process flow is shown for simplicity, any of the functions or operations can be performed in one or more or processes, routines, or sub-routines of one or more algorithms, by one or more devices or systems.

It should be understood that the steps, operations, or functions of the processes 400 are not necessarily presented in any particular order and that performance of some or all the operations in an alternative order is possible and is contemplated. The processes can also be combined or overlap, such as one or more operations of one of the processes being performed in the other process.

The operations have been presented in the demonstrated order for ease of description and illustration. Operations can be added, omitted and/or performed simultaneously without departing from the scope of the appended claims. It should also be understood that the illustrated processes 400 can be ended at any time.

In certain embodiments, some or all operations of the processes 400 and/or substantially equivalent operations are performed by a computer processor, such as the hardware-based processing unit 106, executing computer-executable instructions stored on a non-transitory computer-readable storage device, such as any of the data storage devices 104, or of a mobile device, for instance, described above.

V.B. System Components and Functions

FIG. 4 shows the components of FIG. 3 interacting according to various exemplary algorithms and process flows.

The input module 302, stored at the non-transitory storage device 104 and executed by a processor such as the hardware-based processing unit 106, receives any of a wide variety of input data or signals, including from the sources described in the previous section (IV.).

Input sources include vehicle sensors 60 and local or remote devices 34, 50 via the vehicle communication sub-system 30. Inputs can also include a vehicle database represented by and/or accessed by the illustrated database module 304.

Inputs to any of the sub-modules 304₁₋₇ can include historic or other stored data from the database module 306, or from an extra-vehicle source such as a remote server 50. Other potential sources include user mobile devices, other user computers. The stored data in various embodiments include vehicle-dynamics or -operations data, from vehicle sensors or sub-systems, indicating speed, vehicle location, temperature, etc.

Input data is passed to the activity module 304 after any culling, formatting, conversion, or other processing at the input module 302.

The activity module 304 in various implementations may also be programmed to request (pull), receive without request (push), or otherwise obtain relevant data from input sources, such as the database module 306.

The database module 306 may include, or be part of, or in communication with storage portions of the vehicle 10, such as a portion storing the ancillary data mentioned. The ancillary data may include one or more user profiles. The profiles can be pre-generated by at the system and/or received from one or more remote sources, such as a server 50 or a remote user computer.

The profile for each user can include user-specific preferences communicated to the system by the user, such as via a vehicle touch-screen, a vehicle microphone interface, a smartphone, wearable, etc.

User preferences may include any setting affecting a manner by which the system operates, such as controlling vehicle operation, authenticating users seeking a ride, interacting with the user, and interacting with a non-vehicle system such as a remote server or user device, to send and/or received data relevant to implementation of the present technology. Example preferences include volume, tone, or other sound preferences for delivery of media to the vehicle cabin for user enjoyment, and type or volume of notifications provided to the user.

Information from the database module 306 can also include historic data representing past activity between the system and a user, between the system and other users, or other such systems and these or other users, for instance. As an example, if on repeated occasions, in response to receiving a certain notification, a user turns down a volume in their acoustic zone, the system can generate historic data for that user causing the system to use a lower-volume for such notification.

Output from the database module 306 can be received and processed at any of the other modules, such as to update a user profile with a data indicating a determined preference, activity taken regarding the user, or user behavior including user actions in, or reactions to, certain circumstances.

Activity of any of the sub-modules 304₁₋₇ can include updating or initiating update of historic or user-preference data, whether the data is maintained at the vehicle 10, at a user device 34, and/or at a remote computing device 50. Any such other devices may include a same or related application as the one that may be operating at the vehicle for the present technology, and a server is configured to work with any such application.

Preferences can also be received from a remote profile, such a profile stored at a user mobile device 34 or a remote server 50, and local and remote profile features can be synchronized or shared between any of the at-vehicle systems, user mobile devices 34, and remote servers 50.

Based on inputs and its programming, the activity module 304 performs various operations described expressly and inherently herein. The operations can be performed by one or more sub-modules 304₁₋₇:
ride-scheduling sub-module 304₁,
pre-registration sub-module 304₂,
registration sub-module 304₃;
an introduction or opening sub-module 304₄;
concierge sub-module 304₅;
closing sub-module 304₆; and
post-ride-activities sub-module 304₇.

The ride-scheduling sub-module 304₁ receives information indicating a planned ride in the vehicle 10. If the vehicle is a taxi or ride-sharing vehicle, for instance, scheduling or ride-plan data can indicate people who have signed up for a ride in the vehicle 10 at a certain time. Ride-plan data can include a route or itinerary for each passenger's planned ride, such as time, origin, and destination for each passenger.

The ride-plan data can be received at the ride-scheduling sub-module 304₁ from a specialized application operating on a user device, for instance. As mentioned, complimentary versions or instances of the application can be maintained at subject vehicles, user devices, such as phones, tablets, laptops, etc., as well as at remote servers or customer-service center computers. Some or all of the modules 110 and sub-modules are part of the vehicle-hosted version of the application. The ride-scheduling sub-module 304₁ of the vehicle may receive ride-plan data from a ride-scheduling sub-module of a user device 34, for instance, such as via a communication network 40 or a short-range connection such as Bluetooth.

In contemplated embodiments, users can interact with the system by channels other than directly by an application or program, such as by a phone touch-tone system, or phone call center personnel.

In a contemplated embodiment, a user can schedule an automated-driving ride—whether a shared ride, taxi, etc.—at the vehicle, such as by arriving at the vehicle unannounced (i.e., no pre-registration) and registering there at the vehicle. The user may already have an account for vehicle use, such as by being a subscriber or previous user of the ride service.

The activity module 304 can use the ride-plan data in a variety of ways. The activity module 304 in various embodiments uses the ride-plan data to confirm that each passenger entering or already in the vehicle 10 is identified in a ride plan.

The pre-registration sub-module 304₂ and the registration sub-module 304₃ can be viewed, generally, as course and fine, or relatively lower and relatively higher, levels of security checks.

The pre-registration sub-module 304₂ in various embodiments performs a pre-registration regarding a user approaching, entering, or occupying the vehicle 10 before a ride commences, or in some implementations after started. The vehicle 10 receives and/or generates a manifest or scheduled-passenger data indicating which passengers are scheduled to ride.

The pre-registration can include, as an example, receiving an identifying communication from a mobile device, such as a smartphone, radio-frequency identification (RFID) tag, or smartwatch, carried or worn by each user. In this case, the pre-registration is considered a relatively low-level security check because it is possible, for instance, that, though a device owner of a mobile device (e.g., a parent) has pre-scheduled a taxi or shared ride in a vehicle 10, another person (e.g., teenage child) could be in possession of the device owner's mobile-device.

The pre-registration in another contemplated embodiment includes the system soliciting or otherwise receiving from the person a code via a vehicle interface, such as by a vehicle microphone, keypad, or personal mobile device, as a few examples. The code may have been provided to the user with a ride confirmation, for instance, such as a paper or electronic ticket by email or text, or other conformation. Or the code may be a user- or system-established code or password.

A code-based pre-registration is in some embodiments considered a relatively low-level security check because another person may have obtained the code. The same is true in some implementations regarding personal device possession, as another person may have obtained possession of the personal device—e.g., mobile phone.

The pre-registration in a contemplated embodiment includes (a) obtaining a sensed occupant weight, height, or other physical characteristic—measured by a seat-weight sensor, camera, radar, etc., and (b) comparing the sensed characteristic(s) to pre-stored value(s) for the same regarding the person seeking to use the ride service.

The pre-registration is helpful in many scenarios. As an example, the vehicle system can be programmed to perform the pre-registration on users as they approach or arrive at a vehicle 10, before entering. If a person is not able to pass the pre-registration, the system can take any of a variety of security-enforcement actions, such as to keep the person from entering the vehicle (e.g., locking vehicle doors), moving the vehicle away from the apparently non-registered or non-authorized person, to notify others (e.g., project a voice message advising scheduled passengers), or to notify authorities, a customer-service center (e.g., an OnStar® Center), or a vehicle owner or remote operator.

And the system can be programmed to take any such steps if a person does not pass the subsequent registration, of the next sub-module 304₃.

The registration sub-module 304₃ performs a security check, and if there is a pre-registration, the check is in some cases a higher-level, or stricter, check. In a contemplated embodiment, the registration has a similar level of security as that of the pre-registration, with a difference between the two being that the registration occurs later. The pre-registration and registration can include, for instance, a user selected password and a booking code; or a password or code and possession of a mobile device having pre-registered ID

In various embodiments, the registration function includes a bio-metric or physiological validation. This type of validation may include any one or more of retina, finger print, or facial, or voice, for instance. In a contemplated implementation, the registration includes a password or code, whether a prior pre-registration included a different code. The pre-registration could include a code from a paper or e-ticket, for instance, and the registration code can include a user-set password, or vice versa.

The registration in various embodiments includes sending an image of the user, taken via vehicle camera, to a remote customer service center 50, such as the OnStar system, mentioned. There, facial recognition is performed automatically, or a service-center personnel confirms that the image is apparently of the proper person. Or the facial-recognition processing may be performed at the vehicle.

While in various embodiments, the system includes a distinct pre-registration sub-module 304₂ and separate registration sub-module 304₃, whether they interact with each other, in some other embodiments the system includes a single module or sub-module for performing both pre-registration and registration functions.

In still another implementation, there is no pre-registration function, only a single registration for each ride, and the level of security thereof can be set at any desired level—anywhere between very strict, high level (e.g., retina scan) and a relatively low level (e.g., passcode, password, or user device match).

A pre-registration is preferred in some implementations, providing a relatively quick and easy manner to confirm that the person being analyzed is likely the appropriate person. In this way, most, if not a vast majority or even all of the people that are evaluated by the subsequent registration module 304₃ are the appropriate persons.

If the pre-registration or registration sub-module 304₂, 304₃ determines that a person is not authorized to be a passenger for a ride in a subject vehicle 10, any of a wide variety of output actions can be performed. Output actions can include providing a warning alert to vehicle occupants or other systems (mobile phone, remote computer) or other parties, such as parents, a vehicle owner or operator, authorities, or a customer-service center.

In one embodiment, the pre-registration and/or registration sub-modules 304₂, 304₃ is/are configured to interact with the passenger to gain more information to use in determining whether the passenger is appropriate, to share with a remote system (e.g., customer service center), and/or for the record, in case later investigation or system updates are needed.

The record may be helpful to later investigations, including by the vehicle operator or authorities—police, parent, employer, etc.

The system may, in response to the person trying to take a ride they had not scheduled, assign a demerit to an account pre-associated with, or created at the time for, the person, for instance. Or the system may add to such account an indication that the person cannot subsequently schedule a ride with the subject ride-share arrangement. The latter, expulsion action may be in response to the person receiving a pre-set number of demerits.

Regarding the pre-registration and registration, for instance, historic data may indicate that a particular person has on multiple occasions attempted to ride in a vehicle that they were not pre-registered to use.

The system, via the pre-registration sub-module 304₂, for instance, may thus take a more aggressive stance with the person, such as by (a) initiating a disqualification process whereby the system, locally or via remote device (e.g., application server 50) adjusts a user profile or system settings to indicate that the person is disqualified from further use of the subject vehicle-sharing or taxi service, and (b) advising the person that they are disqualified from any further use of the subject vehicle-sharing or taxi system.

The activity module may be or include a communication module configured to, when executed, initiate or otherwise perform various communications with authenticated persons using the vehicle. The communication-module functions can be performed by one or more sub-modules, such as an opening or introduction sub-module 304₄, a concierge sub-module 304₅, a closing sub-module 304₆; and a post-ride-activities sub-module 304₇.

In various embodiments, upon registration of a passenger, the introduction or opening sub-module 304₄ is executed to begin interacting with the passenger. Interactions can include, to start, presenting greeting information to the passenger via one or more interfaces. The sub-module 304₄, as any component described herein can be referred to by any of a variety of names. Here the sub-module can also be referred to as a passenger-greeting sub-module 304₄.

The interface by which the sub-module 304₄ communicates with each passenger may include one or more HMIs of the vehicle, such as a vehicle speaker system and display screen. The interface can, instead or also, include one or more HMIs of a user device 34, such as a passenger phone or wearable device in communication with the vehicle 10, via the vehicle communication component 30.

The greeting information can include any of a wide variety of comforting or informative messages for the passenger. Goals of providing the greeting information include (a) confirming for the passenger that they are in the proper vehicle, engendering trust with both the ride-share/taxi system and vehicle in particular, making them feel comfortable and welcome, and (b) confirming for them their itinerary or destination as recorded in the ride-plan data, (c) estimated time or arrival, and (d) expected situations along the ride, such as new traffic and its source, as just a few example.

The introductory messaging can also promote a safe or safer feeling in the passenger by helping them appreciate that they are in the vehicle they are supposed to be in, and that each of any other passengers has also been authenticated and so is supposed to be in the vehicle as well.

In various embodiments, the opening sub-module 304₄ determines where a passenger is positioned in the vehicle 10, and associates the location in the vehicle 10 with that passenger for the ride. The system can use the association in various ways, such as in connection with communications with the passenger during the ride, such as by presenting greeting and concierge information to a display screen or speakers focused at the passenger's position. The screen can be positioned directly in front of the seat, for instance, and the speakers can be positioned in the seat head rest.

In some implementations, the corresponding output can also be shared between positions. For instance, the vehicle 10 may include a first screen depending from the ceiling in front of the second-row seats, and a second screen depending from the ceiling in front of third-row seats. When a message is intended for one or more second-row passengers, it can be displayed on the first screen, such as anywhere on the screen or on a side (left) of the screen (e.g., left) corresponding to a side of the second row that the second-row passenger is sitting; and when a message is intended for a third-row passenger, it can be displayed on the second screen in a similar manner.

Example greeting information can include any of the following, presented via visual and/or audio HMI, of the vehicle 10 and/or user device 34:
(i) “Hello, Bob Smith, welcome to your (shared-ride/taxi-service vehicle)”;
(ii) “It will take only 15 minutes to take you to TransAmerica Building;” and
(iii) “Bob, would you like (the app) to make a reservation at the (lobby restaurant) for lunch at the TransAm Building?”

After any initial greetings and interaction of the opening sub-module 304₄, the concierge sub-module 304₅ determines any further communications to make with the passengers during the ride.

The communications determined by the concierge sub-module 304₅ can include any of various types of communications for improving the user experiences, such as informative, inquiring, or comforting communications. In one embodiment, the latter two examples above (ii), (iii) (regarding welcome and commute time) are considered concierge message, following an initial greeting like the first example (i) above (regarding the system potentially arranging a hotel reservation for the user).

Goals of the concierge service interaction include to continue to engender passenger trust, confidence, security, and comfort with the autonomous vehicle 10 and associated ride service.

In this way, the concierge sub-module 304₅ in various embodiments operates to understand each passenger, including their needs. The concierge sub-module 304₅ in various embodiments implements learning protocols, such as computational intelligence, or heuristic programming, or the like, for interacting in a personal and effective manner with a passenger in order to meet passenger needs or provide service not expected.

The concierge sub-module 304₅ in various embodiments also determines any vehicle adjustments that would improve the experience of the passenger(s). The determination can be based on passenger input, such as a request to turn down the temperature, roll up a window, or drive or corner more slowly, for instance.

Or the determination can be based on stored passenger data, such as user preferences stored at the vehicle 10 or remotely—e.g., server 50 or user device 34—and received at the concierge sub-module 304₅ from the input module 302 and/or the database module 306. The preference data may indicate, for instance, that each passenger prefers to listen to classical music during their ride, or while on the highway. Other preferences for any passenger can relate to preferred temperature, whether they prefer to be addressed by first or last name, or preferred modes of communication, such as by way of a vehicle HMI, such as a vehicle screen, or a vehicle audio system, or by a portable user device, such as text or pop-up notifications by way of a user phone, for instance.

In various embodiments, the concierge sub-module 304₅ is configured to respond to user input, such as user requests for information or, as mentioned, adjustments to vehicle operation. Or to respond to information from the user device 34—e.g., “Mr. Smith, we notice that the power level on your phone is low—there is a power cord for your type of phone in the arm-rest on your right.” The system may be programmed to receive a signal or message from the phone, for instance, indicating the lower power level, or the vehicle may have heard Mr. Smith mention the same issue verbally.

The closing sub-module 304₆ can be considered as a counterpart to the opening sub-module and/or the concierge sub-module 304₅. in various implementations.

The closing sub-module 304₆ in a contemplated embodiment facilitates payment for the ride with the passenger, if not already handled by the opening sub-module 304₄ or via a corresponding application, such as a same app, on a user device 34, for instance, that the user used to book the ride.

The closing sub-module 304₆ may be programmed to provide or receive any of various communications to the user as they approach or reach their destination. Messages provided to the passenger prior to arrival can be provided by the closing or concierge sub-module 304₆, 304₅. The communications can, again, be provided by an HMI directed to a subject passenger for the communication—such as a seat-embedded speaker where the passenger is seated.

Example closing information can include any of the following, presented, for instance, via visual and/or audio HMI, of the vehicle and/or user device 34:
(a) “Mr. Smith, we will soon (or, ‘in 5 minutes’) be arriving at the your destination, the TransAmerica Building;”
(b) “Mr. Smith, would you like (the app) to make a reservation at the (lobby restaurant) for lunch at the TransAm Building?”
(c) “Mr. Smith, we have arrived at the your destination, the TransAmerica Building;”
(d) “We hope that you have a great flight and visit to San Francisco;”
(e) “We hope that you had a nice ride—would it be okay to send you a post-ride questionnaire (or link to a rating page)?” and
(f) “Have a great day.”

The post-ride-activities sub-module 304₇ in various cases provides a survey, including one or more inquiries, to the passenger about their ride, to gauge their experience. The survey can be provided by any technique, including via the application on the user device 34 for the autonomous ride-share/taxi service, via the vehicle 10 as the destination is being approached, or briefly at the stop, or after the passengers has left the vehicle. The survey can be provided via an automated phone call—allowing user selections via phone buttons, or email or text link, for instance.

In various embodiments, the post-ride-activities sub-module 304₇ further interacts with the passenger after the stop, and possibly as they have moved away from the vehicle, to determine if the application can assist them with their next steps, such as in making a reservation at a restaurant, pre-checking them in at the airport (which would also be an earlier, concierge communication), etc.

### VI. ADDITIONAL STRUCTURE, ALGORITHM FEATURES, AND OPERATIONS

In addition to or in combination with any of the embodiments described above, the present technology can include any structure or perform any functions as follows:
(i) The technology in various embodiments describes a system that can automatically identify individuals attempting to use an autonomous shared or taxi vehicle service, promoting safety, trust, and enhanced user experience. These benefits, and especially safety and trust, are believed to go hand-in-hand, and to be essential human needs for a technology such as that of the present technology
(ii) The technology in various embodiments is configured to provide an end-to-end autonomous shared vehicle or taxi experience, such as from reservation of the vehicle, to connection by interactions between the vehicle with the person, to an in-car personalized user experience, to release of the customer, and to post-ride activities such as communications such as a survey to obtain user feedback or to assist the user with a potential next, post-ride, activity for the user, such as reservation for a hotel stay, reservation for a restaurant, reservation for another ride.
(iii) The technology in various embodiments is configured to provide automatic, robust identification of each passenger, prior to allowing the passenger to ride, engendering trust and comfort in any registered and authenticated users.
(iv) The technology in various embodiments is configured to provide an enhanced user experience in autonomous shared or taxi services based on the robust pre-ride passenger authentication, and user interaction, including the vehicle automatically greeting each passenger by name, for instance.
(v) The technology in various embodiments is configured to provide safety functions for execution if a person who accesses the autonomous vehicle, attempts to access the vehicle, or approaches the vehicle to access the vehicle, is not a person for which a ride has been scheduled. The functions may include any suitable actions, such as denying entry, not driving the vehicle until the person leaves, advising a customer service center, and notating database records to identify the person for later consideration regarding any future interactions with the person, as a few examples.
(vi) The technology in various embodiments is configured to provide an in-vehicle personalized user experience. The passenger can reserve the taxi via an application accessible at their mobile device, for instance. And by way of the mobile device, they can receive information about the vehicle's location as it approaches the user for a pick-up. The information can include data about how to access/enter the taxi, such as a code to unlock the door or to use for being authenticated by the vehicle.
(vii) The technology in various embodiments is configured to automatically identify the user via connection with a user mobile device, and particularly by way of a subject application operating at the mobile device. In various embodiments, the shared or tax autonomous vehicle is configured to re-check, or re-verify identity of the customer after they enter, such as in a higher-level security check—e.g., using an in-vehicle camera(s).
(viii) The system may further be configured to provide an alert in case the person is not a scheduled, or registered, person. The alert can be provided to a customer service center (e.g., OnStar® Center), or an authority (e.g., parent, vehicle operator, vehicle owner), for instance.
(ix) In various embodiments, the registration module determines whether data obtained about a person being authenticated indicates that the person satisfies pre-established requirements for a ride, such as by not having a criminal record, not being intoxicated, and not having one or more instances of misconduct in prior rides, as just a few examples.
(x) The technology in various embodiments is configured to use information received and stored at the vehicle about the passengers authenticated in interacting with the passenger, such as in opening interactions when the passenger is authenticated, concierge functions during the ride, closing interactions as a passenger stop approaches or is reached, and post-ride interactions with the passenger.

### VII. SELECT ADVANTAGES

Many of the benefits and advantages of the present technology are described above. The present section restates some of those and references some others. The benefits described are not exhaustive of the benefits of the present technology.

Interactions with the passenger, including the authentication, greeting, concierge, closing, and post ride communications, can include comforting or informative messages for the passenger. The system is configured in various embodiments to provide the communications in a gentle manner, including by gentle, pleasing voice, appropriate volume for the conditions—e.g., speaker location, ambient noise, etc.

Various goals are promoted by functions of the system, including (a) confirming for the passenger that they are in the proper vehicle, engendering trust with both the ride-share/taxi system and vehicle in particular, making them feel comfortable and welcome, and (b) confirming with them as accurate their itinerary or destination as recorded in the ride-plan data. The introductory messaging can also promote the passenger feeling safe, knowing that they are in the vehicle they are supposed to be, and that each other passenger has also been authenticated and so are supposed to be in the vehicle.

The technology allows greater customization of autonomous driving experiences to the passenger or passengers riding in the vehicle, and can notify interested parties (parents, vehicle operator, authorities, etc.) of relevant or notable circumstances involving the ride or the passenger(s).

The technology in operation enhances driver and/or passenger satisfaction, including comfort, with using automated driving by adjusting any of a wide variety of vehicle characteristics selectively, such as vehicle driving-style parameters and climate controls.

The technology will lead to increased automated-driving system use. Users are more likely to use or learn about more-advanced autonomous-driving capabilities of the vehicle as well.

A relationship between the user(s) and a subject vehicle can be improved—the user will consider the vehicle as more of a trusted tool, assistant, or friend based on interactions with, and other functions of, the present technology.

The technology can also affect levels of adoption and, related, affect marketing and sales of autonomous-driving-capable vehicles. As users' trust in autonomous-driving systems increases, they are more likely to purchase an autonomous-driving-capable vehicle, purchase another one, or recommend, or model use of, one to others.

Another benefit of system use is that users will not need to invest effort in setting or calibrating automated driver style parameters, as in various embodiments, many of the parameters (e.g., user preferences for HVAC, infotainment, driving style, passenger-mix preference, etc.) are set or adjusted automatically by the system, to minimize user stress and therein increase user satisfaction and comfort with autonomous-driving vehicles and their functionality.

### VIII. CONCLUSION

Various embodiments of the present disclosure are disclosed herein. The disclosed embodiments are merely examples that may be embodied in various and alternative forms, and combinations thereof.

The above-described embodiments are merely exemplary illustrations of implementations set forth for a clear understanding of the principles of the disclosure.

References herein to how a feature is arranged can refer to, but are not limited to, how the feature is positioned with respect to other features. References herein to how a feature is configured can refer to, but are not limited to, how the feature is sized, how the feature is shaped, and/or material of the feature. For simplicity, the term configured can be used to refer to both the configuration and arrangement described above in this paragraph.

Directional references are provided herein mostly for ease of description and for simplified description of the example drawings, and the systems described can be implemented in any of a wide variety of orientations. References herein indicating direction are not made in limiting senses. For example, references to upper, lower, top, bottom, or lateral, are not provided to limit the manner in which the technology of the present disclosure can be implemented. While an upper surface is referenced, for example, the referenced surface can, but need not be vertically upward, or atop, in a design, manufacturing, or operating reference frame. The surface can in various embodiments be aside or below other components of the system instead, for instance.

Any component described or shown in the figures as a single item can be replaced by multiple such items configured to perform the functions of the single item described. Likewise, any multiple items can be replaced by a single item configured to perform the functions of the multiple items described.

Variations, modifications, and combinations may be made to the above-described embodiments without departing from the scope of the claims. All such variations, modifications, and combinations are included herein by the scope of this disclosure and the following claims.

What is claimed is:

1. A system, for implementation with an autonomous vehicle, comprising:
hardware-based processing unit;
a human-machine interface; and
a non-transitory storage device comprising:
a registration module that, when executed by the hardware-based processing unit:
obtains passenger registration data indicating multiple identifications corresponding respectively to multiple passengers registered to use an autonomous-vehicle driving service; and
determines whether each of multiple persons attempting to ride in the autonomous vehicle is one of the passengers registered for the autonomous-vehicle driving service, yielding respective authentications regarding persons determined to be one of the passengers registered for the service; and
a vehicle-passenger communication module that, when executed by the hardware-based processing unit, initiates intra-vehicle communication with at least one of the passengers authenticated by way of the human-machine interface of the vehicle or a personal device of the at least one passenger.

2. A system, for implementation with an autonomous vehicle, comprising:
a non-transitory storage device comprising:
a registration module that, when executed by a hardware-based processing unit:
obtains passenger registration data indicating multiple identifications corresponding respectively to multiple passengers registered to use an autonomous-vehicle driving service; and
determines whether each of multiple persons attempting to ride in the autonomous vehicle is one of the passengers registered for the autonomous-vehicle driving service, yielding respective authentications regarding persons determined to be one of the passengers registered for the service; and
a vehicle-passenger communication module that, when executed by the hardware-based processing unit, initiates intra-vehicle communication with at least one of the passengers authenticated by way of a human-machine interface of the vehicle or a personal device of the at least one passenger.

3. The system of claim 2 wherein the vehicle-passenger communication module comprises a passenger-greeting sub-module that, when executed by the hardware-based processing unit, provides an introduction communication to the at least one passenger.

4. The system of claim 3 wherein the passenger greeting sub-module, when executed, generates the introduction communication being personalized to the at least one passenger.

5. The system of claim 4 wherein the introduction communication includes a name of the at least one passenger.

6. The system of claim 2 wherein the vehicle-passenger communication module comprises a concierge sub-module that, when executed by the hardware-based processing unit, delivers an inquiry to the at least one passenger by way of the human-machine interface.

7. The system of claim 6 wherein the concierge sub-module, when executed, receives a passenger response and initiates an action based on the response.

8. The system of claim 2 wherein the vehicle-passenger communication module comprises a concierge sub-module that, when executed by the hardware-based processing unit, determines a manner to adjust a vehicle apparatus personal to the at least one passenger.

9. The system of claim 8 wherein:
the vehicle apparatus comprises a climate apparatus; and
the concierge sub-module, when executed, determines the manner by which to adjust the climate apparatus based on passenger-data indicating a preference or desire of the at least one passenger.

10. The system of claim 8 wherein:
the vehicle apparatus comprises an infotainment apparatus; and
the concierge sub-module, when executed, determines the manner by which to adjust the infotainment apparatus based on passenger-data indicating a preference or desire of the at least one passenger.

11. The system of claim 8 wherein:
the vehicle apparatus comprises an autonomous-driving apparatus; and
the concierge sub-module, when executed, determines the manner by which to adjust the autonomous-driving apparatus based on passenger-data indicating a preference or desire of the at least one passenger.

12. The system of claim 2 wherein the non-transitory storage device comprises a closing-communication sub-module that, when executed by the hardware-based processing unit, determines a passenger-personalized end-of-ride communication to provide to the at least one passenger near the end of a ride.

13. The system of claim 12 wherein the passenger-personalized end-of-ride communication is configured to advise the at least one passenger that their destination is approaching.

14. The system of claim 12 wherein the passenger-personalized end-of-ride communication is configured to determine whether the at least one passenger would like the system to affect a post-ride passenger activity.

15. The system of claim 14 wherein the post-ride passenger activity includes at least one of a restaurant reservation, a hotel reservation, and entertainment reservations.

16. The system of claim 2 wherein determining whether each of multiple persons attempting to ride in the autonomous vehicle is one of the passengers registered for the autonomous-vehicle driving service comprises:
a lower-level security check; and
a higher-level security check.

17. The system of claim 2 wherein the vehicle-passenger communication module, when executed:
determines a position of the at least one passenger in the vehicle; and
provides the introduction communication by way of a human-machine interface of the vehicle focused on the position in the autonomous vehicle for receipt primarily by the at least one passenger.

18. The system of claim 2 wherein the registration module, when executed by the hardware-based processing unit, determines an authentication-failure action to take in connection with each non-authenticated person, who attempting to ride in the autonomous vehicle but determined to not be registered.

19. The system of claim 18 wherein the authentication-failure action comprises one or more:
providing an alert communication to a passenger of the vehicle;
providing an alert communication to the non-authenticated person;
providing an alert communication to an authority;
applying a demerit to respective accounts for each non-authenticated person; and
adjusting the respective accounts so that each non-authenticated person can no longer use the autonomous-vehicle driving service.

20. A system, for implementation with an autonomous vehicle, comprising:
a non-transitory storage device comprising a vehicle-passenger communication module that, when executed by the hardware-based processing unit, initiates intra-vehicle communication with at least one of the passengers authenticated by way of a human-machine interface of the vehicle or a personal device of the at least one passenger;
wherein the vehicle-passenger communication module comprises:
a passenger-greeting sub-module that, when executed by the hardware-based processing unit, provides an introduction communication to the at least one passenger;
a concierge sub-module that, when executed by the hardware-based processing unit, delivers an inquiry to the at least one passenger by way of the human-machine interface and/or determines a manner to adjust a vehicle apparatus personal to the at least one passenger; and
a closing-communication sub-module that, when executed by the hardware-based processing unit, determines a passenger-personalized end-of-ride communication to provide to the at least one passenger near the end of a ride.
